(19) United States
(12) Patent Application Publication
(10) Pub. No.: US 2026/0220270 A1
(43) Pub. Date: Jul. 30, 2026

(54) SECURE BOOT FOR VIRTUAL MACHINES

(71) Applicant: International Business Machines Corporation, Armonk, NY (US)

(72) Inventors: Reinhard Theodor Buendgen, Tuebingen (DE); Hendrik Bruckner, Boblingen (DE)

(21) Appl. No.: 19/037,642

(22) Filed: Jan. 27, 2025

(51) Int. Cl. G06F 21/57; G06F 21/64

(52) U.S. Cl. CPC G06F 21/575; G06F 21/572; G06F 21/64

(57) ABSTRACT

A method, according to one approach, includes: receiving an activation request for a program that implements a guest boot loader. The activation request is received at a kernel in a verified hypervisor. The method also includes creating a process configured to run the program. A determination is made as to whether a signature of the process is valid. In response to determining the signature of the process is valid, the process is labeled as verified. Moreover, in response to receiving a system call from the process to run guest code in a virtual machine, a determination is made as to whether the process is valid. In response to determining the process is not verified, the received system call is rejected.

### BACKGROUND

The present invention relates to code verification, and more specifically, this invention relates to securely booting verified code.

As the complexity of software and software based systems continues to increase, so does the desire for improved security based features. For example, “secure boot” is a security feature that has been developed for computers that ensures only trusted software that has been verified by digital signatures can be started by the boot process of a system. This prevents malicious code from compromising the system when it first starts up by checking the authenticity of the software to be booted before allowing it to execute.

A general purpose operating systems is not a closed system and is meant to start an arbitrary program. Therefore, secure boot restricts the code to be verified to a subset of code that is considered crucial for the security of the program execution. For example, for the LINUX operating system only code that runs in privileged mode (i.e. the kernel) is verified and a verified kernel will enforce that all modifications to the kernel are verified. While secure boot provides an added layer of protection against malware and other types of computer security attacks, it is also complex to apply across different types of systems.

For instance, in situations where an operating system (e.g., software) being loaded is not a simple operating system, but rather a hypervisor or some other system that is able to start further operating systems (e.g., such as in virtual machines), there is no way to assure that only verified code is executed. This is due at least in part to the fact that hypervisors (even a securely booted hypervisor) are able to boot further operating systems as desired. As a result, in situations where a hypervisor is booted, the privileged code of the hypervisor is verified as part of the secure boot, but that hypervisor itself is able to run a boot loader to start yet another operating system (e.g., such as a virtual machine). Accordingly, a need exists for products that are able to enforce restrictions on elements run by the hypervisors.

### SUMMARY

A method, according to one approach, includes: receiving an activation request for a program that implements a guest boot loader. The activation request is received at a kernel in a verified hypervisor. The method also includes creating a process configured to run the program. A determination is made as to whether a signature of the process is valid. In response to determining the signature of the process is valid, the process is labeled as verified. Moreover, in response to receiving a system call from the process to run guest code in a virtual machine, a determination is made as to whether the process is verified. In response to determining the process is not verified, the received system call is rejected.

A computer program product, according to another approach, includes: one or more computer-readable storage media. The computer program product also includes program instructions that are stored on the one or more storage media to perform any combination of the foregoing methodologies.

A computer system, according to yet another approach, includes: a processor set, and one or more computer-readable storage media. The computer system also includes program instructions that are stored on the one or more storage media to cause the processor set to perform any combination of the foregoing methodologies.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of the components in a distributed system, in accordance with one approach.

FIG. 2B is a more detailed representational view of the distributed system in FIG. 2A, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for securely booting virtual machines from a verified kernel in a hypervisor using guest boot loaders, is illustrated in accordance with one approach. Approaches herein may thereby serve as a preliminary step of initiating verified code in an environment regardless of the configuration and/or the source of the code that has been verified. Approaches herein are desirably able to ensure that only verified code is executed even in open systems accessing remote locations, thereby improving system security while simultaneously improving system throughput by improving interoperability, e.g., as will be described in further detail below.

In one general approach, a method includes: receiving an activation request for a program that implements a guest boot loader. The activation request is received at a kernel in a verified hypervisor. The method also includes creating a process configured to run the program. A determination is made as to whether a signature of the process is valid. In response to determining the signature of the process is valid, the process is labeled as verified. Moreover, in response to receiving a system call from the process to run guest code in a virtual machine, a determination is made as to whether the process is valid. In response to determining the process is not verified, the received system call is rejected.

Approaches herein are thereby able to enforce that only verified code is executed, regardless of the system configuration. Implementations having bootloaders with processes that are attempting to start virtual machines are able to ensure the privileged code of the virtual machines themselves is verified before starting them. While this verification may be somewhat straightforward for closed systems in which all code may be verified, it is a complicated issue for open systems, e.g., such as LINUX based systems, in which various types and layers of software may be installed across a remote system. Approaches herein are thereby able to ensure that bootloaders started in any type of securely booted system are themselves only able to trigger secure boots for virtual machines, regardless of the system configuration. This may be achieved by the approaches herein by only executing code that is has been verified and marked (e.g., labeled) as such.

In some implementations, the guest code is started in a virtual machine in response to verifying the process and executing the received system call. Moreover, the hypervisor and the virtual machine are not in a closed system. It follows that the improvements achieved herein are applicable to any type of system configuration. As noted above, approaches herein are able to enforce that only verified code is performed, regardless of the system configuration. For instance, bootloaders that are attempting to start virtual machines are able to ensure the privileged code of the virtual machines themselves is verified before starting them. Approaches herein are thereby able to ensure that bootloaders started in any type of securely booted system are themselves only able to trigger secure boots for virtual machines, regardless of whether the system is open or closed. This may be achieved by the approaches herein by only executing code that is has been verified and marked (e.g., labeled) as such.

In some implementations, an initial verification request is received for the hypervisor. Thus, in response to receiving an initial verification request for the hypervisor at a firmware boot loader, a determination is made as to whether a signature of the kernel in the hypervisor is verified. In response to the signature of the kernel being verified, a certificate of trustworthiness configured to verify a process that runs a program implementing a guest boot loader is received. Moreover, the process of determining whether a signature of the kernel in the hypervisor is verified includes using a second certificate of trustworthiness received for the kernel.

The received certificate of trustworthiness may be copy of an original certificate of trustworthiness stored at the firmware boot loader. Moreover, the original certificate of trustworthiness may originate from a trustworthy provider of boot loaders. In other words, the original certificate of trustworthiness may be established by a manufacturer of the boot loaders and/or another trusted source, and shared with logical components (e.g., firmware boot loaders, boot loaders, hypervisors, etc.) that have been verified. It follows that different certificates of trustworthiness may be used for different signature verification procedures. This assists with ensuring that only code that has been verified may be run even in open systems, e.g., as will be described in further detail below.

In some implementations, the process of determining whether a multi-component guest code is valid includes inspecting different components of the multi-component guest code. Moreover, the multi-component guest code is verified in response to all of the components being verified. Again, it follows that the improvements achieved herein are applicable to any type of code configuration. For example, even code assembled from different libraries may be verified in full by initially confirming that each of the libraries from which the code was loaded are verified. After the libraries are each verified, the process as a whole may be marked as verified and executable. Bootloaders that run in user space may thereby perform the verified process (e.g., issue the verified system call) to start and/or resume a removed virtual machine. Again, approaches herein are thereby desirably able to ensure that only verified code is executed even in distributed systems accessing remote locations, thereby improving system security while simultaneously improving system throughput by improving interoperability, e.g., as will be described in further detail below.

In some implementations, the process of determining whether the signature of the process is verified includes using a certificate of trustworthiness to verify the signature of the process against program code. As noted above, the certificate of trustworthiness may be received at a firmware boot loader in response to the kernel being verified. In some instances, even the process of determining whether the guest code is valid includes using the certificate of trustworthiness to verify the program against a program code of the process. Moreover, the original certificate of trustworthiness may originate from a trustworthy provider of boot loaders. In other words, the original certificate of trustworthiness may be established by a manufacturer of the boot loaders and/or another trusted source, and shared with logical components (e.g., firmware boot loaders, boot loaders, hypervisors, etc.) that have been verified. This assists with ensuring that only code that has been verified may be run even in open systems.

In some implementations, the verified process is permitted to start the virtual machine and run the guest code in response to determining the process is verified. Running the guest code includes accessing the second certificate of trustworthiness from the kernel. The guest code is verified using the second certificate of trustworthiness. Moreover, in response to successfully verifying the guest code, a system call is issued from the process to run the verified guest code in the virtual machine.

Approaches herein are thereby able to enforce that only verified code is executed, even in virtual machines. Thus, implementations having bootloaders with processes that are attempting to start virtual machines are able to ensure the privileged code of the virtual machines themselves is verified before starting them. Approaches herein are thereby able to ensure that bootloaders started in any type of securely booted system are themselves only able to trigger secure boots for virtual machines, regardless of the system configuration.

In one general approach, a computer program product includes: one or more computer-readable storage media. The computer program product also includes program instructions that are stored on the one or more storage media to perform any combination of the foregoing methodologies.

In yet another general approach, a computer system includes: a processor set, and one or more computer-readable storage media. The computer system also includes program instructions that are stored on the one or more storage media to cause the processor set to perform any combination of the foregoing methodologies.

In other implementations, a request to start a guest boot loader program is submitted by a user and/or running program to a kernel in a verified hypervisor. In response to receiving the request, the kernel creates a guest boot loader process based at least in part on information (e.g., metadata) received along with the request. The kernel also inspects a digital signature correlated with the guest boot loader program that the received request references. In other words, the kernel determines whether the signature of the guest boot loader is verified. In situations where the signature of guest boot loader program can be verified, the guest boot loader process is labeled as being verified. However, in situations where the signature of guest boot loader program cannot be verified, the guest boot loader process is labeled as being non-verified. In situations where the guest boot loader process is labeled as being verified, the kernel starts the guest boot loader process using components of the guest boot loader program. In situations where the guest boot loader process links to one or more libraries having code that is not signed by a valid signature, then the guest boot loader process is labeled as being not verified and is not performed. However, in situations where the guest boot loader process links to one or more libraries having code that is signed by valid signature(s), then the guest boot loader process is labeled as being verified and is performed. Accordingly, the guest boot loader issues a system call to run verified guest code, but the system call rejects the call if the guest boot loader process is labeled as not-verified. Again, this desirably ensures that only verified code is performed, even in open systems which has been conventionally unachievable.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as new verification code at block 150 for securely booting virtual machines from a verified kernel in a hypervisor using guest boot loaders, is illustrated in accordance with one approach. Approaches herein may thereby serve as a preliminary step of initiating verified code in an environment regardless of the configuration and/or the source of the code that has been verified. Approaches herein are desirably able to ensure that only verified code is executed even in open systems accessing remote locations, thereby improving system security while simultaneously improving system throughput by improving interoperability, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

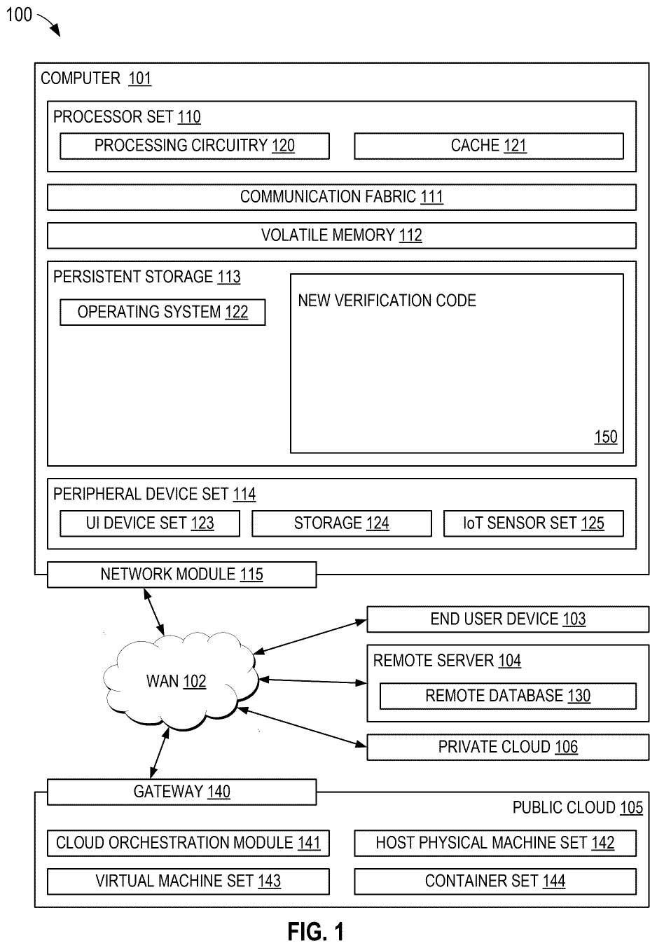

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As the complexity of software and software based systems continues to increase, so does the desire for improved security based features. For example, “secure boot” is a security feature that has been developed for computers that ensures only trusted software that has been verified by digital signatures can run during the boot process of a system. This prevents malicious code from compromising the system when it first starts up by checking the authenticity of the boot software before allowing it to execute. While this provides an added layer of protection against malware and other types of computer security attacks, conventional products have had trouble implementing this verification across different types of systems.

For example, in situations where an operating system (e.g., software) being loaded is not a simple operating system, but rather a hypervisor or some other system that is able to start further operating systems (e.g., such as in virtual machines), there is no way to assure that only verified code is executed. In other words, conventional products are unable to enforce that hypervisors (even a securely booted hypervisor) are only able to securely boot further operating systems. As a result, in situations where a hypervisor is booted, the privileged code of the hypervisor is verified as part of the secure boot, but that hypervisor itself is able to run a boot loader to start yet another operating system (e.g., such as a virtual machine), and conventional products have no way to enforce any restrictions on the additional boot loader(s) run by the hypervisor. Accordingly, conventional products have suffered from limited functionality and stifled compute throughput rates as a result of intentionally limiting performance in the interest of improved system security.

In sharp contrast to these conventional shortcomings, approaches herein are able to enforce that only verified code is performed, regardless of the system configuration. Thus, approaches having boot loaders attempting to start remote virtual machines are able to ensure the privileged code of the virtual machines themselves is verified before starting them. While this verification may be somewhat straightforward for closed systems in which all code may be verified, it is a complicated issue for open systems, e.g., such as LINUX based systems, in which various types and layers of software may be installed across a distributed system. Approaches herein are thereby able to ensure that boot loaders started in any type of securely booted system are themselves only able to trigger secure boots for virtual machines, regardless of the system configuration. This may be achieved by the approaches herein by only executing code that is has been verified and marked (e.g., labeled) as such.

According to an example, initiating a process (e.g., system call) assembled with code from different libraries involves initially confirming that each of the libraries from which the code was loaded are verified. After the libraries are each verified, the process as a whole may be marked as verified and executable. Boot loaders that run in user space may thereby perform the verified process (e.g., issue the verified system call) to start and/or resume a removed virtual machine. Again, approaches herein are thereby desirably able to ensure that only verified code is executed even in open systems accessing remote locations, thereby improving system security while simultaneously improving system throughput by improving interoperability, e.g., as will be described in further detail below.

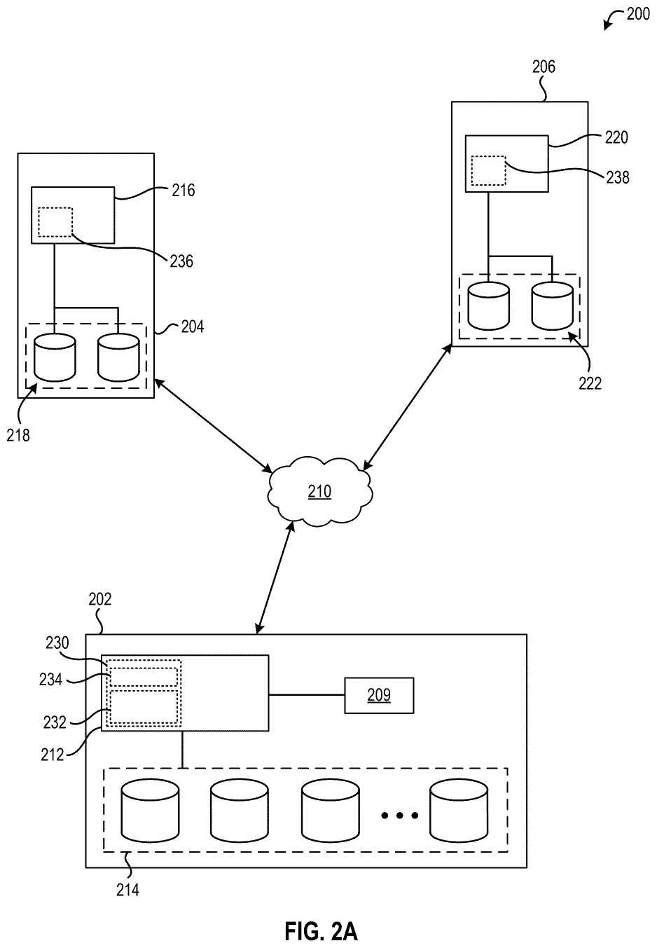

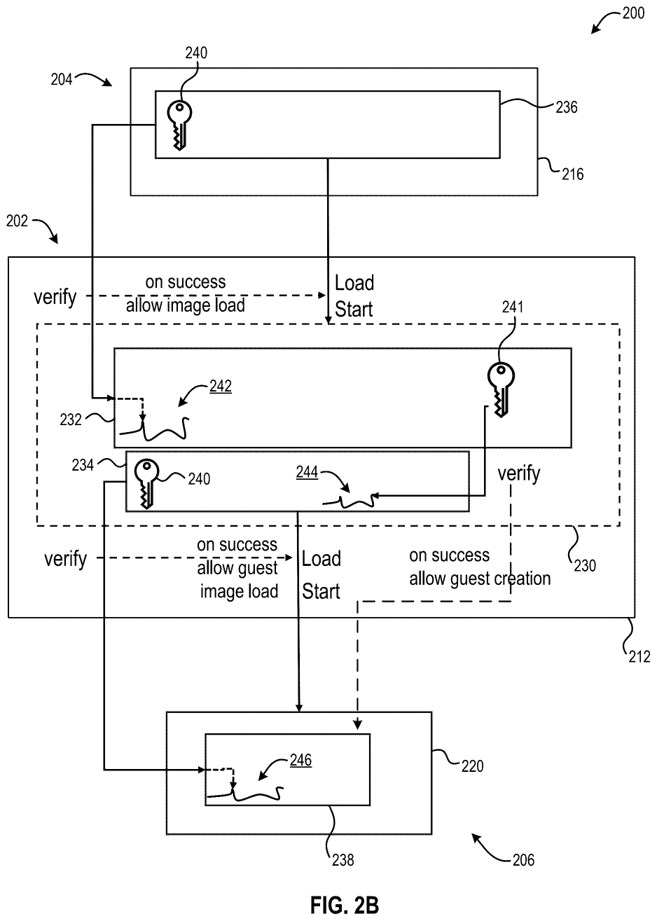

Looking now to FIGS. 2A-2B, a representational view of a distributed system 200 that is able to achieve system security across open systems having any desired number of reference layers is shown in accordance with one approach. Specifically, FIG. 2A provides a representational view of the physical components that are included in the distributed system 200 in accordance with one approach. FIG. 2B illustrates a more detailed view of the interactions between verified components at different locations in the system 200 presented in FIG. 2A.

However, this is in no way intended to be limiting, and one or more of the components shown in FIGS. 2A-2B may be implemented differently in other approaches. According to an example, physical components may be replaced with corresponding virtual elements. For instance, one or more of the processors in FIG. 2A may be replaced by virtual processors in some approaches. In other approaches, one or more of the physical processor components may be replaced by containers or virtual machines (VMs). As noted above, this “open” system configuration allows for improved functionality, but has been conventionally unachievable in such systems without exposing them to sever security vulnerabilities.

It should also be noted that the present system 200 may be implemented in conjunction with features from any other approach listed herein, such as those described with reference to the other FIGS. However, this system 200 and others presented herein may be used in various applications and/or in permutations which may or may not be specifically described in the illustrative approaches or implementations listed herein. Further, the system 200 presented herein may be used in any desired environment. Thus, FIGS. 2A-2B (and the other FIGS.) may be deemed to include any possible permutation.

As shown in FIG. 2A, the distributed system 200 includes a number of physical components therein. For instance, the system 200 is illustrated as including a central node 202 that is connected to a first node 204 and a second node 206. Specifically, the central node 202, first node 204, and second node 206 are each connected to a network 210. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc., may be sent between the nodes 204, 206, and/or 202, regardless of the amount of separation which exists therebetween, e.g., despite being positioned at different geographical locations.

It should also be noted that two or more of the nodes 204, 206, 202 may be connected to each other differently depending on the approach. According to an example, which is in no way intended to limit the invention, two or more edge nodes (e.g., compute nodes) may be located relatively close to each other and connected by a wired connection, e.g., a cable, a fiber-optic link, a wire, etc., or any other type of connection which would be apparent to one skilled in the art after reading the present description.

With continued reference to FIG. 2A, the first and second nodes 204, 206 may have a different configuration than the central node 202. For instance, the first and second nodes 204, 206 may be edge nodes, while the central node 202 serves as a central location that offers scalable cloud computing and/or data storage. In other approaches, the first node 204 may be a user device (e.g., personal computer, mobile phone, tablet, etc.), the second node may be an edge node, and the central node 202 may server as a central processing and/or storage location. Accordingly, the first node 204 includes a processor 216 coupled to memory 218, and second node 206 includes a processor 220 coupled to memory 222, while central node 202 includes a large (e.g., robust) processor 212 that is coupled to a cache 209 and a data storage array 214 having a relatively high storage capacity (e.g., at least a higher storage capacity than the cache 209). The central node 202 is thereby able to process and store a relatively large amount of data, allowing it to be connected to, and manage, multiple different remote nodes (e.g., edge node servers).

Each of the processors 212, 216, 220 may be able to verify and run one or more logical components (e.g., kernel(s), boot loader(s), hypervisor(s), virtual machine(s), etc.) therein. Accordingly, operating systems (OSs) at the respective nodes 202, 204, 206 may be able to utilize the verified components in order to satisfy program activation requests in a secure manner while also improving computational throughput. As such, processor 212 is shown as supporting (e.g., running) a hypervisor 230, which in turn includes a kernel 232 and a boot loader 234. Looking to processor 216, there an application is running a firmware boot loader 236 and may issue an activation request directed to the central processor 212. For instance, the application and/or firmware boot loader 236 itself may issue an activation request to the boot loader 234, which in turn may be configured to initiate guest code in a virtual machine at another remote location. Accordingly, processor 220 is depicted as supporting (e.g., running) a virtual machine 238.

Referring now to FIG. 2B, a more detailed view of the logical components and corresponding processors are shown in accordance with one approach. Looking first to processor 216 in node 204, there a firmware boot loader 236 includes a source copy of a certificate of trustworthiness 240. The firmware boot loader 236 issues an initial verification request to the hypervisor 230 in processor 212. In response to receiving the verification request, a signature 242 of the kernel 232 in the hypervisor 230 is inspected. In preferred approaches, the certificate of trustworthiness 240 is used to verify the signature 242 of the kernel 232. In response to the signature 242 of the kernel 232 being verified, an image load is permitted and a copy of the certificate of trustworthiness 241 is received at and/or from the firmware boot loader 236. In some approaches the certificate of trustworthiness 241 may have originated from a trustworthy provider of boot loaders, e.g., as would be appreciated by one skilled in the art after reading the present description.

Activation requests may also be received at the kernel 232. For instance, an activation request may be received for a program that implements guest boot loader 234. In some approaches, the guest boot loader 234 is configured to run guest code in a virtual machine. In other words, the guest boot loader being activated may be able to initiate and run guest code in a virtual machine. While this improves functionality, it has exposed conventional products to significant security risks stemming from the fact that verification cannot be performed prior to implementing guest code. However, approaches herein are desirably able to overcome these conventional shortcomings and ensure that even user code in a virtual machine is verified before being implemented.

With continued reference to FIG. 2B, the kernel 232 uses the program referenced in the received activation request to implement the guest boot loader 234. In other words, the kernel 232 initiates the guest boot loader 234 such that details therein may be evaluated before being fully run. For instance, the copy of the certificate of trustworthiness 241 at the kernel 232 may be used to check a signature 244 of the guest boot loader. In response to the signature 244 of the guest boot loader being approved, the guest boot loader and/or programs used to run the guest boot loader may be marked as valid. Accordingly, a copy of the certificate of trustworthiness 240 is shared with the guest boot loader 234. However, in response to determining the signature 244 of the guest boot loader 234 is not valid, the program and/or guest boot loader 234 are labeled as non-verified and the received activation request is denied. As referred to herein, a logical component, code, etc., that is marked as “valid” or “verified” refers to something that has been compared against one or more security policies, capability baselines, performance ranges, etc., and has been identified as meeting any desired prerequisites. For example, code that has been inspected for and cleared of any malicious components, functional errors, unauthorized modifications, etc. may be marked as being valid or validated.

Furthermore, in response to receiving a system call from the guest boot loader 234 that is labeled as verified to run guest code in the virtual machine 238, additional verification is performed. Specifically, the guest boot loader 234 inspects a signature 246 of the guest code in the virtual machine 238. The hypervisor 230 and/or the kernel 232 therein preferably uses the copy of the certificate of trustworthiness 240 to evaluate the signature 246 of the guest code. In response to determining the guest code is not verified, causing the received system call to be rejected. However, in response to determining the boot loader code is valid, the received system call is permitted to be executed, allowing for the verified guest code in the virtual machine to be run by the verified guest boot loader 234. Again, this desirably enforces that only verified code is performed, regardless of the system configuration. Approaches herein are thereby able to ensure that boot loaders started in any type of securely booted system are themselves only able to trigger secure boots for virtual machines, regardless of the system configuration, which has not been conventionally achievable, e.g., as will be described in further detail below.

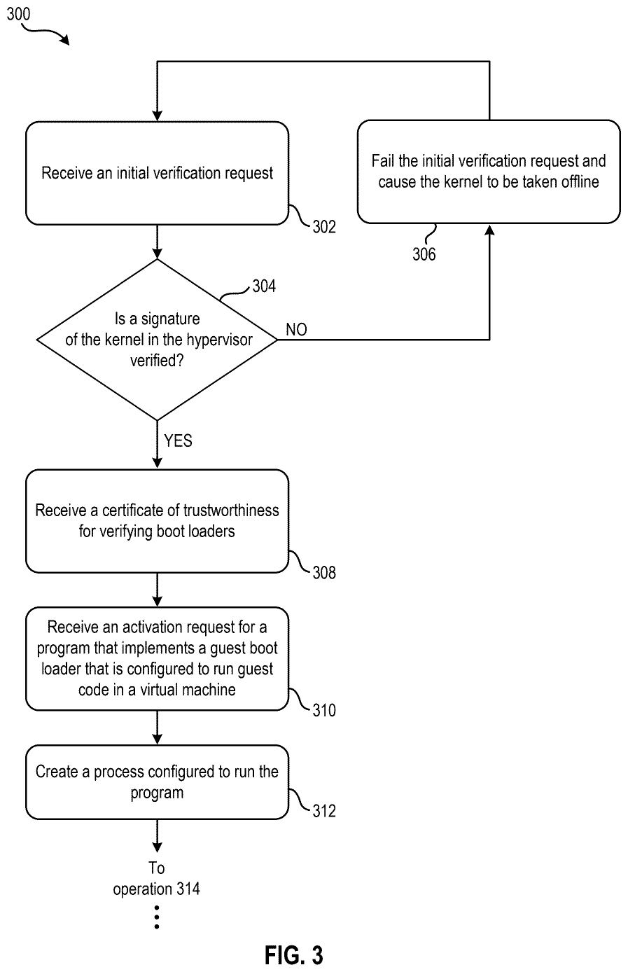

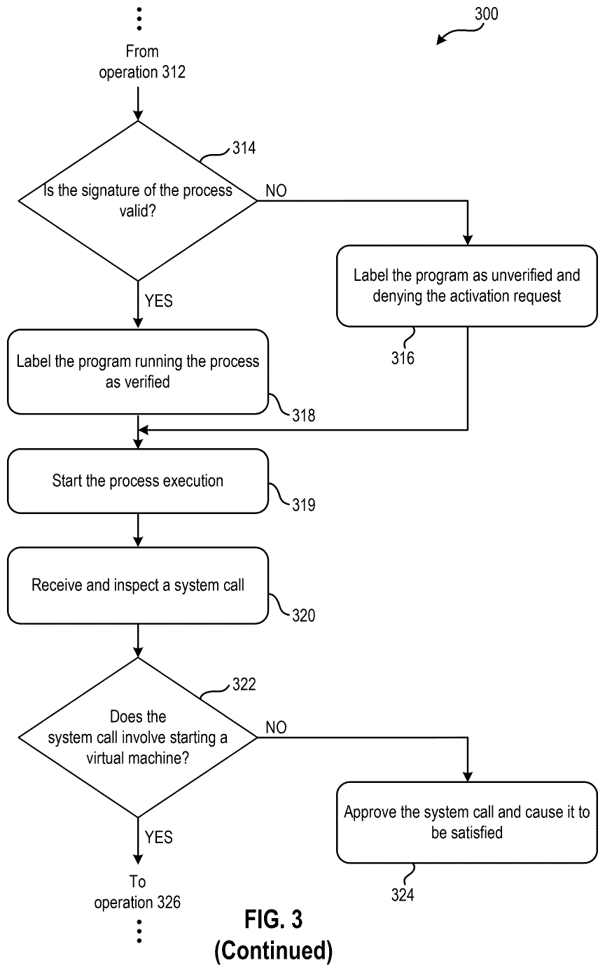

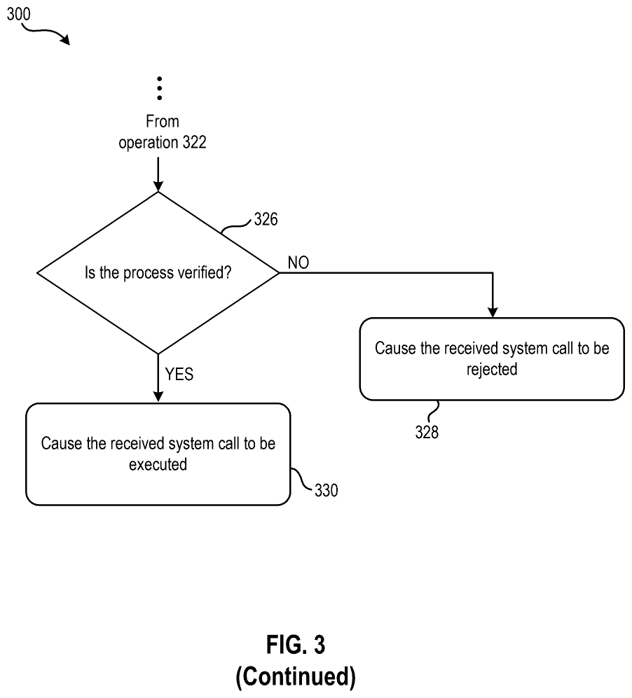

Referring now to FIG. 3, a method 300 for securely booting virtual machines from a verified kernel in a hypervisor using guest boot loaders, is illustrated in accordance with one approach. One or more of the operations there may thereby serve as a preliminary step of initiating verified code in an environment regardless of the configuration and/or the source of the code that has been verified. The method 300 may be performed in accordance with any of the environments depicted in FIGS. 1-2B, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in some approaches one or more of the operations in method 300 may be performed by a processor and/or logical components therein (e.g., see hypervisor 230 of processor 212 in FIGS. 2A-2B). However, the method 300 may be partially or entirely performed by a controller, a processor, a computer, etc., or some other device having one or more processors therein. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It should be noted that at least some of the operations in method 300 are described in the context of approaches that have specific configurations, which are in no way intended to be limiting. For example, operations in method 300 that involve starting and/or presuming operation of a virtual machine involves the execution of a privileged instruction, e.g., such as a Start Interpretive Execution (SIE) instruction. Approaches herein also implement processes which are able to load trustworthy certificates into securely booted kernels. Approaches herein also involve systems which permit privileged (e.g., verified) codes to gain access to certificates of trustworthiness. Some approaches may also assume that trustworthy providers only sign trustworthy boot loaders and executables which can be verified using corresponding certificates. Moreover, it may be assumed that transferring a CPU core or threat into a state where it runs the code of a virtual machine first involves verifying the code and obtaining privilege to run the code.

Looking to FIG. 3, operation 302 includes receiving an initial verification request. As noted above, one or more operations of method 300 may be performed by a hypervisor at a central processor. Accordingly, an initial verification request may be received for a hypervisor identified as having boot loaders that are configured to run guest code in virtual machines. This may maintain a desired level of security across a distributed system by ensuring that all code is verified before being run, which again has not been achievable.

In some approaches, the initial verification request is received at a firmware boot loader that may be attempting to initiate (e.g., run) a hypervisor. The initial verification request may be issued automatically in some instances as part of a predetermined security protocol. However, in some approaches a hypervisor may not be verified before it is used. For instance, a hypervisor may have previously been verified, certain tasks may not call for verification, etc. Accordingly, operation 302 (and/or operation 304) may be optional in some approaches.

In situations where an initial verification request is received at the firmware boot loader, method 300 advances from operation 302 to operation 304. There, operation 304 includes evaluating the verification request and determining whether a signature of the kernel in the hypervisor is verified. As used herein, a “signature” denotes any representation of a cryptographic signature, e.g., which may include unique combinations of characters and/or information. For example, a signature as used in the approaches herein may implement (e.g., utilize) cryptographic digital signature keys. Depending on the approach, these keys may be formed using a key generation algorithm and stored in memory. Moreover, the keys may be formed in pairs of private and public keys. A signing algorithm that, given a message and a private key, thereby produces a digital signature. This digital signature may also be verified by a signature verifying algorithm based at least in part on the message, the public key, and the digital signature.

The signature of the kernel in the hypervisor may be verified using a copy of the certificate of trustworthiness at the firmware boot loader. In preferred approaches the kernel signature is compared with the copy of the certificate of trustworthiness at the hypervisor. However, in some approaches at least a portion of the kernel signature (e.g., a public signature) may be returned to the firmware boot loader and compared with the certificate of trustworthiness.

In response to determining that the signature of the kernel is not verified, method 300 advances from operation 304 to operation 306. There, operation 306 includes failing the initial verification request and causing the kernel to be taken offline (e.g., restricted). In some approaches, an overarching hypervisor managing the kernel may be restricted, modified, sequestered, flagged for inspection, etc. From operation 306, method 300 may keep the kernel and/or hypervisor offline a predetermined amount of time, until a predetermined condition is met, while waiting to be replaced, etc. before being reactivated and returning to operation 302.

However, method 300 advances from operation 304 to operation 308 in response to determining that the signature of the kernel is verified. There, operation 308 includes receiving a certificate of trustworthiness for verifying guest boot loaders. In some approaches the received certificate of trustworthiness is a copy of an original certificate of trustworthiness stored at the firmware boot loader. Moreover, the original certificate of trustworthiness may originate from a trustworthy provider of boot loaders. In other words, the original certificate of trustworthiness may be established by a manufacturer of the boot loaders and/or another trusted source, and shared with logical components (e.g., firmware boot loaders, boot loaders, hypervisors, etc.) that have been verified. This assists with ensuring that only code that has been verified may be run even in open systems, e.g., as will be described in further detail below. Moreover, the received copy of the certificate of trustworthiness is preferably stored in memory of the hypervisor kernel.

From operation 308, method 300 advances to operation 310. There, operation 310 includes receiving an activation request for a program that implements a guest boot loader that is configured to run guest code in a virtual machine. In other words, the activation request involves a program that is able to run code that is virtualized inside the hypervisor of which the kernel is already verified. While the activation request may be received from the guest boot loader, in other approaches the activation request may be received from alternate sources. For instance, one or more applications running in the verified hypervisor may issue the activation request. Regardless of where the activation request is received from, operation 312 includes creating a process configured to run the program. In other words, the program referenced in the received activation request is formed, initiated, and run, thereby causing the process to be started.

From operation 312, method 300 advances to operation 314. There, operation 314 includes inspecting a signature of the process and determining whether the signature of the process is valid. In preferred approaches, a copy of the certificate of trustworthiness is used to verify the signature of the process. As noted above, a certificate of trustworthiness may be received at a firmware boot loader in response to the kernel and/or hypervisor being verified. The certificate of trustworthiness is preferably configured to verify a process that runs a program implementing a guest boot loader. The certificate of trustworthiness may thereby be a certificate that is designated to verifying processes that run programs which implement guest boot loaders. Thus, any desired number of certificates of trustworthiness may be stored in hardened memory (e.g., internal to the processor running the kernel and/or hypervisor) may be compared against the signature of the process to determine if it is verified.

With continued reference to FIG. 3, method 300 advances from operation 314 to operation 316 in response to determining the signature of the process is not valid. There, operation 316 includes labeling the program as unverified. Even unverified processes may run, but unverified processes are not permitted to call a system call to start a virtual machine. In other words, while the activation request itself may be received at a kernel in a hypervisor that is already verified, the program(s) referenced in the activation request may initiate and/or run boot loaders in open systems that are capable of running guest code in virtual machines that are not incorporated in the verified kernel or hypervisor, and which should not be trusted if verification fails. In some approaches, one or more warnings indicating the failed verification may be generated and transmitted to a system administrator, the source of a failed activation request may be barred from issuing additional requests, the verified kernel and/or hypervisor may be temporarily taken offline, etc. From operation 316, method 300 advances to operation 319, as will be described in further detail below.

Returning to operation 314, method 300 advances to operation 318 in response to determining that the signature of the process is valid. There, operation 318 includes labeling the program running the process as verified. Moreover, operation 319 includes starting the process execution, while operation 320 includes receiving a system call to run code and inspecting the system call. In some approaches a received system call involves running guest code in a logical component that is different (e.g., remote) from the verified kernel and/or hypervisor. For instance, as noted above, the process may be configured to run guest code in a virtual machine.

Accordingly, the process may issue system calls that involve running the guest code in a virtual machine. However, the process may also issue system calls that involve running code in the local hypervisor itself. Accordingly, any received system calls are preferably examined to determine whether they involve running virtual machine code. It should also be noted that while system calls which involve running guest code in a virtual machine are typically received from the process, the same or similar system calls may be received from other sources. Thus, regardless of where system calls are received from, they are preferably inspected for requests that involve running code remotely.

In response to inspecting the received system call, method 300 advances from operation 320 to operation 322. There, operation 322 includes determining whether the received system call involves starting a virtual machine. In other words, operation 322 includes determining whether the system call initiates guest code running in a logical component that is different from the verified kernel and/or hypervisor. In other words, operation 322 includes determining whether the received system call involves running guest code in a virtual machine. Method 300 advances from operation 322 to operation 324 in response to determining that the system call received from the process does not involve running guest code in a virtual machine. There, operation 324 includes approving the system call and causing it to be satisfied. In other words, operation 324 includes performing the received system call in response to determining it is nominal and will not expose the system to any unverified security risks.

However, method 300 advances from operation 322 to operation 326 in response to determining that the system call received from the process does involve running guest code in a virtual machine. There, operation 326 includes determining whether the code of the calling process is labeled as verified. In some approaches, the guest code itself may be inspected to determine whether it is valid. In other approaches, metadata associated with the guest code may be inspected to determine validity. In some approaches, a signature of the guest code is inspected to determine validity. For example, a cryptographic signature assigned to (e.g., correlated with) the guest code attempting to be run in the virtual machine may be inspected and compared against a copy of the certificate of trustworthiness. In response to the certificate of trustworthiness verifying the signature of the guest code, the guest code itself may be established as verified.

In some approaches, the guest boot loader code is multi-component code which includes components or “portions” of code from two or more different sources (e.g., libraries). The process of determining whether this multi-component guest code is valid in operation 314 thereby includes inspecting each of the different components of the multi-component guest code. Preferably, the multi-component guest code is only verified in response to all of the components therein being successfully verified.

Method 300 advances from operation 326 to operation 328 in response to determining that the code of the calling process is not verified. There, operation 328 includes causing the received system call to be rejected. In other words, non-verified guest boot loader code and thus unverified guest code is denied and not performed in order to maintain improved system security. Operation 328 may also include issuing a warning to a system administrator, flagging a source of the system call that initiated the non-verified guest code, taking the virtual machine running the non-verified guest code offline, flagging a signature of the non-verified guest code to identify duplicates in the system, etc.

Returning to operation 326, method 300 alternatively proceeds to operation 330 in response to determining that the code of the calling process is labeled as verified. In other words, operation 330 is performed in response to identifying that the guest code poised to run in the virtual machine and impact the performance of a verified environment, is itself verified. There, operation 330 includes marking the guest code as verified and causing the received system call to be executed in response to determining the guest boot loader code is labeled as verified. As noted above, “verified” as used herein refers to a logical component (e.g., kernel, boot loader, code, virtual machine, firmware boot loader, etc.) that has been compared against one or more security policies, capability baselines, performance ranges, etc., and has been identified as meeting any desired prerequisites. For example, code and/or processors configured to run code may be inspected for and cleared of any malicious components, functional errors, unauthorized modifications, etc. may be marked as being valid or verified.

It follows that operations of method 300 are desirably able to ensure that securely booted kernels verify every signed executable that is loaded, using a certificate of a trustworthiness, which may originate from a provider of boot loaders. Accordingly, the kernel has a certificate of trusted boot loader writer and when a new executable is started, it is first loaded by the kernel and verified. If the signature can be verified with the certificate of a trustworthiness, then the executable is marked as verified and can reliably be performed without exposing the system to security threats.

Again, this desirably allows for even open systems to operate with insulation from malicious attempts at infiltrating a verified system, which has not been conventionally achievable. Accordingly, approaches herein are able to verify guest code run in virtual machines that are external to a verified hypervisor running verified code. In other words, the hypervisor is not a “closed hypervisor” or in a “closed system” that permits secure boots of virtual machines to occur. Rather, the hypervisor is able to connect to any desired virtual machines (e.g., as is the case in the LINUX operating system). Thus, approaches herein are able to verify guest code that is even in a virtual machine displaced from the hypervisor. Moreover, a program that is performed internally to the verified hypervisor and which does not implement a guest boot loader can be initiated and run even though it does not have a signature. Similarly, a program that does not implement a guest boot loader can be started even though its signature cannot be verified. Some approaches herein may even implement verification checks by using IMARC technology, e.g., as would be appreciated by one skilled in the art after reading the present description.

Approaches herein thereby desirably extend the secure boot trust chain to virtual machines being booted inside a securely booted environment (e.g., hypervisor). This is achieved at least in part by the secure boot of the hypervisor enforcing that any boot loader used to start a virtual machine does correctly check the trustworthiness of the operating system that is to be started in the virtual machine. Note this boot loader (e.g., qemu) is typically not a privileged program, thereby reducing the amount of code that must be proved trustworthy to a minimum (e.g., allow for some non-trustworthy code).

Again, in conventional products, it is not possible to enforce that no other boot loader can be used from a securely booted open hypervisor. According to an example use case which is in no way intended to be limiting, a system admin wishes to enforce (per secure boot) that all privileged code run in their machine is signed, even if the system that is started is a development system (e.g., used to develop, build, and test programs), in which case the system admin wishes to prevent the developer from being able to test a newly developed boot loader that does not check the signature of a booted guest image. This can be solved with this disclosure but not with any products or processes existing in the prior art.

Again, methods herein are used to enforce securely booted hypervisors (e.g., virtual machine monitors) to securely boot a virtual machine having a system that involves privileged code to start a processor, to run virtual machine code. A securely booted kernel (e.g., privileged code) of a hypervisor can enforce that bootloader software in user space (e.g., non-privileged code) can only securely boot a virtual machine. Some approaches enforce a recursive secure boot trust chain for operating systems and hypervisors (e.g. LINUX & KVM) that are securely booted by verifying only privileged code (e.g. kernel) such that all virtual machines to be booted are booted securely.

Approaches herein thereby include methods which are capable of extending a hypervisor kernel to restrict requests from user space to boot a virtual machine. This is achieved by booting, starting, and resuming a virtual machine using privileged instructions. The hypervisor kernel also has access to public keys that can be used to verify trustworthy code, which is code that does not boot a virtual machine using non-secure boot. The hypervisor kernel can label processes that are verified using the public keys, and reject requests to boot, start, resume, etc., a virtual machine from non-labeled processes. These approaches thereby include methods that are able to enforce a securely booted hypervisor (e.g., virtual machine monitor) to securely boot a virtual machine using a system that enforces privileged code to start a processor to run virtual machine code. The hypervisor privileged code also has access to a secure boot certificate, and the hypervisor privileged code labels all processes as to whether all code used by the process could be verified using the secure boot certificate. The hypervisor privileged code also is unable to execute requests to code that involve starting a processor to run virtual machine code if the request was triggered from a process that is not labeled to only run verified code.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving, at a kernel in a verified hypervisor, an activation request for a program that implements a guest boot loader;
creating a process configured to run the program;
determining whether a signature of the process is valid;
in response to determining the signature of the process is valid, labeling the process as verified;
in response to receiving a system call from the process to run guest code in a virtual machine, determining whether the process is verified; and
in response to determining the process is not verified, causing the received system call to be rejected.

2. The method of claim 1, further comprising:
in response to determining the process is verified, causing the received system call to be executed.

3. The method of claim 1, further comprising:
in response to receiving an initial verification request for the hypervisor at a firmware boot loader, determining whether a signature of the kernel in the hypervisor is verified; and
in response to the signature of the kernel being verified, receiving a certificate of trustworthiness configured to verify a process that runs a program implementing a guest boot loader.

4. The method of claim 3, wherein the determining whether a signature of the kernel in the hypervisor is verified includes using a second certificate of trustworthiness at the firmware boot loader.

5. The method of claim 4, further comprising
in response to determining the process is verified, causing the verified process to start the virtual machine and run the guest code by:
accessing the second certificate of trustworthiness from the kernel,
verifying the guest code using the second certificate of trustworthiness, and
in response to successfully verifying the guest code, issuing a system call from the process to run the verified guest code in a virtual machine.

6. The method of claim 1, wherein determining whether a multi-component guest code is valid includes:
inspecting different components of the multi-component guest code; and
verifying the multi-component guest code in response to all of the components being verified.

7. The method of claim 1, wherein the determining whether the signature of the process is verified includes:
using a certificate of trustworthiness to verify a signature of the program against a program code of the process, wherein the certificate of trustworthiness is received at a firmware boot loader in response to the kernel being verified.

8. The method of claim 1, wherein the guest code is started in a virtual machine, wherein the hypervisor and the virtual machine are not in a closed system.

9. A computer program product comprising:
one or more computer-readable storage media; and
program instructions stored on the one or more storage media to perform operations comprising:
receiving, at a kernel in a verified hypervisor, an activation request for a program that implements a guest boot loader;
creating a process configured to run the program;
determining whether a signature of the process is valid;
in response to determining the signature of the process is valid, labeling the process as verified;
in response to receiving a system call from the process to run guest code in a virtual machine, determining whether the process is verified; and
in response to determining the process is not verified, causing the received system call to be rejected.

10. The computer program product of claim 9, wherein the operations further comprise:
in response to determining the process is verified, causing the received system call to be executed.

11. The computer program product of claim 9, wherein the operations further comprise:
in response to receiving an initial verification request for the hypervisor at a firmware boot loader, determining whether a signature of the kernel in the hypervisor is verified; and
in response to the signature of the kernel being verified, receiving a certificate of trustworthiness configured to verify a process that runs a program implementing a guest boot loader.

12. The computer program product of claim 11, wherein the determining whether a signature of the kernel in the hypervisor is verified includes using a second certificate of trustworthiness at the firmware boot loader.

13. The computer program product of claim 9, wherein determining whether a multi-component guest code is valid includes:
inspecting different components of the multi-component guest code; and
verifying the multi-component guest code in response to all of the components being verified.

14. The computer program product of claim 9, wherein the determining whether the signature of the process is verified includes:
using a certificate of trustworthiness to verify a signature of the program against a program code of the process, wherein the certificate of trustworthiness is received at a firmware boot loader in response to the kernel being verified.

15. The computer program product of claim 9, wherein the guest code is started in a virtual machine, wherein the hypervisor and the virtual machine are not in a closed system.

16. A computer system comprising:
a processor set;
one or more computer-readable storage media; and
program instructions stored on the one or more storage media to cause the processor set to perform operations comprising:
receiving, at a kernel in a verified hypervisor, an activation request for a program that implements a guest boot loader;
creating a process configured to run the program;
determining whether a signature of the process is valid;
in response to determining the signature of the process is valid, labeling the process as verified;
in response to receiving a system call from the process to run guest code in a virtual machine, determining whether the process is verified; and
in response to determining the process is not verified, causing the received system call to be rejected.

17. The computer system of claim 16, wherein the operations further comprise:
in response to determining the process is verified, causing the received system call to be executed.

18. The computer system of claim 16, wherein the operations further comprise:
in response to receiving an initial verification request for the hypervisor at a firmware boot loader, determining whether a signature of the kernel in the hypervisor is verified; and
in response to the signature of the kernel being verified, receiving a certificate of trustworthiness configured to verify a process that runs a program implementing a guest boot loader.

19. The computer system of claim 18, wherein the determining whether a signature of the kernel in the hypervisor is verified includes using a second certificate of trustworthiness at the firmware boot loader.

20. The computer system of claim 16, wherein the guest code is started in a virtual machine, wherein the hypervisor and the virtual machine are not in a closed system.
